(19) United States
(12) Patent Application Publication
(10) Pub. No.: US 2014/0149571 A1
(43) Pub. Date: May 29, 2014

(54) Trust-Based Self-Organizing Wireless Network

(71) Applicant: Illuminode LLC, (US)

(72) Inventors: Mads Rune Christensen, Los Angeles, CA (US); Carrie Hart, Palm Jumeirah (AE); Hruby McHugh, Los Angeles, CA (US)

(73) Assignee: Illuminode LLC, Los Angeles, CA (US)

(21) Appl. No.: 13/686,459

(22) Filed: Nov. 27, 2012

(51) Int. Cl. H04L 12/26

(52) U.S. Cl. CPC H04L 43/0805
USPC 709/224

(57) ABSTRACT

A trust-based network has a plurality of nodes, each of which has a node device. Each node device includes a processor, a memory coupled to the processor, and a transceiver coupled to the processor. The transceiver is capable of transmitting signals to, and receiving signals from a second node device in the network. Trust for the transmission of information between nodes is determined using the proximity of one node to another, as well as other factors.

### BACKGROUND OF THE INVENTION

This invention relates to peer-to-peer networks, and in particular to a network which is trust based and self-organizing. Peer-to-peer networks are computer based networks in which each node in the network can provide information directly to, or receive information directly from, another node. This allows communication among the nodes without need for a central server or a network administrator. Each node in the network uses the same, or at least a compatible, protocol to connect to each other and to exchange files or other resources among the nodes.

In conventional peer to peer networks, each node is equally privileged and can freely exchange information with all other nodes. While this has many beneficial aspects, such networks have known disadvantages. In such networks it is relatively easy to distribute harmful data or programs because users of the network are connected to each other without restriction. This enables an adversary to join the network and distribute harmful data, viruses or other undesirable programs.

Some research work has investigated the possibility of differing levels of privilege in a peer-to-peer networks. In a paper entitled “Trust-Based Content Distribution for Peer to Peer Overlay Networks,” published in The International Journal of Network Security and Its Applications, Volume 2, Number 2 April 2010, a system is described in which a trust index is calculated based upon the total number of requests made by a node, the success of data delivery, and the search time.

### BRIEF SUMMARY OF THE INVENTION

We have developed a peer-to-peer trust-based network. Each node in the network functions independently, and without need for a central server or a system administrator. The nodes communicate with each other based upon the concept of “trust.” This trust is a calculated value. In our implementation the value is between 0 and 100 and reflects, using appropriate parameters, how trusting a particular node is with respect to transmission of information to another node, or reception of information from that other node. The calculated trust value can be used to control transmission of data such as files, programs, or other information among the nodes.

Each node device typically includes a processor, a memory coupled to the processor, and a radio frequency transceiver coupled to the processor. The transceiver is capable of transmitting signals to other nodes in the network, and receiving signals from those other nodes. The processor, operating under control of a stored program, calculates the trust value for each of the other nodes with which it communicates using a desired algorithm. In a preferred embodiment each node broadcasts a heartbeat signal to inform other nodes of its presence. The heartbeat signal includes information identifying that node to the other nodes, as well as additional other desired information, for example, any application programs that the transmitting node is executing.

Other factors that can be included in calculation of the trust value include the amount of time elapsed since the heartbeat signal was last received and any previous trust value established for the node. If desired, the node devices can be equipped with devices such as light emitting devices, sound emitting devices, or other peripheral devices. In addition, sensors can be coupled to each node device to detect acceleration, temperature, sound, or other parameters.

The invention also includes a method of providing a trust-based network of node devices which are each capable of emitting and receiving electromagnetic waves. The method is implemented by causing each node device to emit a heartbeat signal identifying that device. When one node device receives a heartbeat signal from another node device, it calculates a trust level for the received signal. This trust level depends in part on proximity, but it can also be based upon other desired factors, e.g., the application being executed by the receiving node or the amount of time which is elapsed since the transmitting node/transmitted.

### BRIEF DESCRIPTION OF THE DRAWINGS

FIG. 1 is a block diagram of a prior art Zigbee network architecture based upon IEEE 802. 15.4;

FIG. 2 is a block diagram of a single node; and

FIG. 3 is a diagram illustrating three node devices, their respective heartbeat signals, and their respective trust levels.

### DETAILED DESCRIPTION OF THE INVENTION

Our system provides a self-organizing, auto-negotiating network topology in which different nodes have differing levels of trust in dealing with other nodes. In our preferred embodiment, the system is based on IEEE 802.15.4 (a basis of Zigbee) but it can be used with other communication protocols. In our system, unlike other network topologies, devices are not just connected or disconnected; they are connected with differing levels of trust. As such the nodes can form complex relationships based on commonalities. In this sense our system mimics the way people interact; as a general rule the better you know someone, the more you trust that individual. A node device may join a group, i.e. the network, briefly and only share limited information with the other devices in the network. As the communication continues and becomes more profound over time, the level of trust increases between the corresponding nodes.

In our preferred implementation, the system relies upon the existing, well-defined IEEE 802.15.4 standard. IEEE 802.15.4 is a standard which specifies the physical layer and media access control for low-speed wireless personal area networks. It is maintained by the IEEE 802.15 working group and is the basis, for example, of the ZigBee network specification. Zigbee extends the standard by providing upper layers which are not defined by 802.15.4. In contrast with end-user oriented approaches, such as 802.11a, g or n (wi-fi), 802.15.4 focuses on low-cost, low-speed communication between devices.

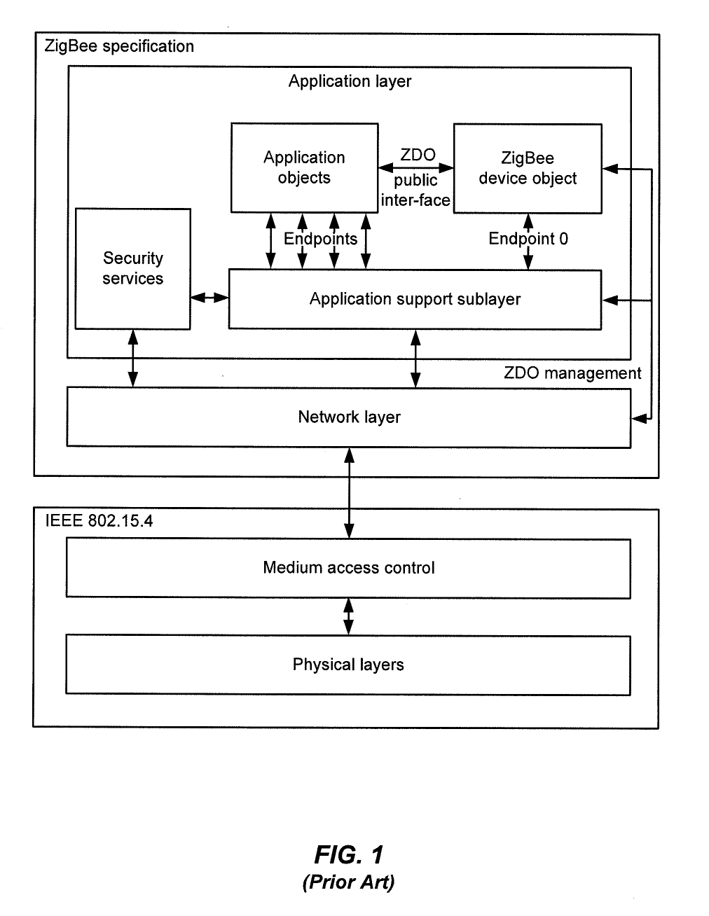

Compliance with this IEEE standard assures that nodes can communicate with each other, regardless of manufacturer. FIG. 1 shows a typical prior art network stack (Zigbee) built on IEEE 802.15.4. The standard defines the physical and media access control layers and in the United States has been allocated frequencies in the 2.4 GHz unlicensed ISM (industrial, scientific, medical) band.

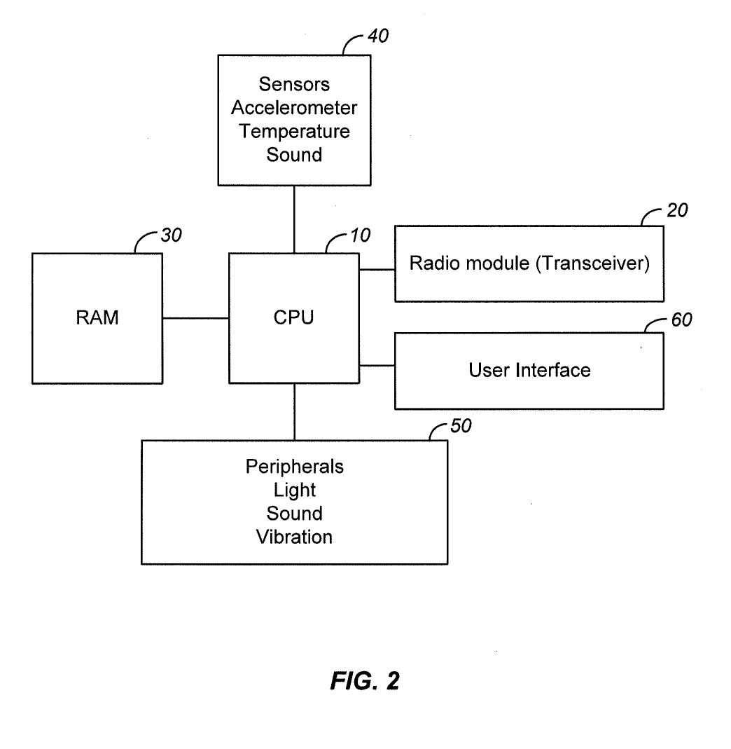

FIG. 2 is a block diagram of a preferred embodiment of a typical node device 5 which implements our trust based network technology. As shown there the device 5 includes a central processing unit 10, typically a commercially available microprocessor such as the PIC32 series available from Microchip Technology Inc. The microprocessor 10 is connected to a radio module 20 which transmits and receives signals using the selected network protocol, preferably IEEE 802.15.4. In a preferred embodiment the radio module is implemented using a commercially available integrated circuit such as the MRF24J40MA, also available from Microchip. The microprocessor 10 is also coupled to random access memory 30 which stores data used by and produced by the microprocessor 10. Preferably memory 30 will be nonvolatile, or regularly copied to nonvolatile memory, enabling retrieval of peer trust levels in the event of a power loss. The trust-based network features are implemented by being programmed directly into the read-only memory of the microprocessor.

As also shown in FIG. 2, appropriate sensors 40 and peripherals 50, depending on the particular applications to be implemented, also may be coupled to the microprocessor 10. The sensors can include devices such as accelerometers, temperature measuring devices, sound detection devices, etc. The peripherals 50 coupled to the microprocessor 10 can include any desired well-known peripherals, for example light emitting devices such as light emitting diodes, sound emitting devices, vibration generating devices, etc. Finally, a user input device 60 is provided to enable the user to interact with the node device 5. This input device can consist of a detachable keyboard, a few buttons on the node device itself, or other well-known user interface devices. Not shown in FIG. 2 is a battery or other power supply used to provide electrical power to all of the components in the node 5.

Next we provide an example of one use of our system. Assume that each node of a network of nodes has an LED light affixed to that node, and that the nodes are portable. Also assume that each node has been configured to rely on a trust factor (as described in detail below) for determining whether and to what extent to communicate with other nearby nodes. In our system each node “belongs” to one or more profiles. The profiles typically represent application software. For example, a profile (“Illumination”) might be a social network, and another profile (“Safety”) might provide lighted bicycle helmets. A single node may belong to multiple profiles simultaneously. New nodes can discover and join existing networks based on the topology of the network and the already connected devices.

In the example just given, if a node is using the Illumination profile and another node approaches which is also using the Illumination profile, these two devices will be more likely to connect on a more trusted (deeper) level than two nodes in which one is using only the Illumination profile and the other only the Safety profile. In our system the trust level may be manually or automatically raised and lowered. In automatic mode, for devices that have been in close range for a sustained period of time, the trust level will gradually rise between the nodes. On the other hand, in the manual mode, the person carrying the node device may raise the level of trust by performing a synchronized “handshake” using a defined protocol with another user, for example, by tapping the two nodes against each other, pressing a button simultaneously, or otherwise entering information. Instant trust may occur if two nodes are unusually close to each other, even for a short duration. In general for many common uses of the node devices, there is no need to manually configure or manage the node devices. Based on its proximity to other trust network enabled devices, as well as possible external stimuli (movement, location, time of day, etc.) the node devices will autonomously manage their relationships with other node devices.

In addition to supporting usage profiles and trust levels, our node devices also support three social modes which we term: Roaming, Socializable and Supervised. In Roaming mode, the node device is completely independent of external control, but may join a group, as chosen by the user. In the Socializable mode, the node device is more open to forming new trust relationships than usual. The normal safeguards are relaxed and trust forms more readily and uninhibitedly than usual. In Supervised mode, the node device is associated with a Supervisor device whose messages will take priority over other messages being received. For instance, this may be used by a mother to communicate with her daughter by overriding all other communication momentarily.

A given location or individual may employ multiple node devices. In such cases our system allows an option to promote one of the devices to a become a “local master” responsible for all external communication. In view of their proximity, the master and slave devices at the same location implicitly enjoy a high level of trust between each other. Trust relationships formed with other node devices automatically propagate from the master node device to the slave node device.

Our system creates trust-based, dynamic, self-organizing networks between radio-connected devices (peers). The principles of operation are hardware agnostic provided common network protocols are used in the node devices. We, however, provide means to uniquely identify each device and measure or otherwise qualify the strength of the signals received from peer node devices.

The underlying communication protocol (packet data structure) is independent from the trust-relationship model, but source and destination addresses must be available. In our preferred implementation we use the standard 802.15.4 packet data structure which allows other devices to exist on the same channel without interfering with each other. Each node device maintains a list of peers known to it. As peers communicate, the trust level increases based on the factors listed below. The list of known peers is only limited by the size which fits within the memory of the node device (or is otherwise readily accessible by the node device). The list of peers is accessible by peer id and by trust level. It is maintained in such a way that if the list is full, the least trusted peers are eliminated first. A peer is identified by a unique identifier, e.g. a MAC address. The list of peers will typically be between 100 and 1000 entries, again depending on hardware limitations, to support large usage scenarios.

We next discuss the preferred approach we use to calculate the trust level for a node. Each peer node is initially assigned a trust level, which for a newly discovered peer is zero. The maximum trust level is 100. In the preferred embodiment the trust level is calculated dynamically based on the following factors:
Proximity: Signal strength, a stronger signal will increase the trust level faster. The range of signal strength is a real number between 0 and 1. The proximity value may be scaled according to local conditions and the type of application. For example, if many nodes are present in a confined space it may be desirable to decrease the sensitivity of the nodes to ensure that only nodes very close to each other will form trust relationships.
Frequency of interaction: More frequent interaction increases the trust level.
   Number of interactions: A higher number increases the trust level.
   Time since last interaction: The trust level decays over time.
   Elapsed time since first interaction: A longer timespan increases the trust level.
   Number of active peers within reach: Fewer peers around indicate a more intimate interaction and increase the trust level faster.
   Type of interaction: Node devices belonging to the same application increase their mutual trust levels faster than peers belonging to different applications.
   Manual override: The operator of the node device may choose to raise or lower the trust level for any given peer.
   Instant trust: Operators of two devices may touch the devices to each other, push a button, or otherwise enter information simultaneously on each device. This will transmit an instant trust signal. If the instant trust signal is received from the other device within a short period, e.g. +/− one second of the local device transmission, an instant trust (=100) is formed. Instant trust may also be formed if two nodes are unusually close for a short duration if the relative signal strength of the heartbeat signal is greater than e.g. 90%,

To support the calculation of trust levels, the following information is stored for each peer node:
Unique id
Current trust level
Last heartbeat (time stamp)
Last signal strength

Each peer broadcasts a “heartbeat” signal including its unique id and class membership(s) every 10 seconds. Only the heartbeat signal is used to determine the trust level between peers. Other information exchanged does not alter the trust level. In the preferred embodiment, the trust level is calculated every 10 seconds for all known peers using the formula:

$${T}_{n + 1} = min \{ 100 \vert {T}_{n} \times D + \frac{S \times C}{min \{ 10 \vert P \}} \}$$

where:

Tₙ is the prior trust level (from 10 seconds previous);

S is the signal strength of the last received heartbeat;

P is the active peer count, determined by counting the peers where the last received heartbeat is less than 60 seconds old. If P is greater than 10, then the value 10 is used;

C is the commonality factor. If the peer has one or more class properties in common with the local device, C is 2, otherwise C is 1;

D is the decay factor. D is

$$\frac{999}{1000} ,$$

and reduces the trust level to by 0.1% every 10 seconds; and

Tₙ₊₁ is the new trust level, limited to 100.

After the trust level has been calculated, the last received signal strength value S is reset to 0, ready to receive the next heartbeat. Once established, the trust level may be used to determine which types of information the application shares with other peers (direct transmission) or accepts from other peers (broadcast transmission).

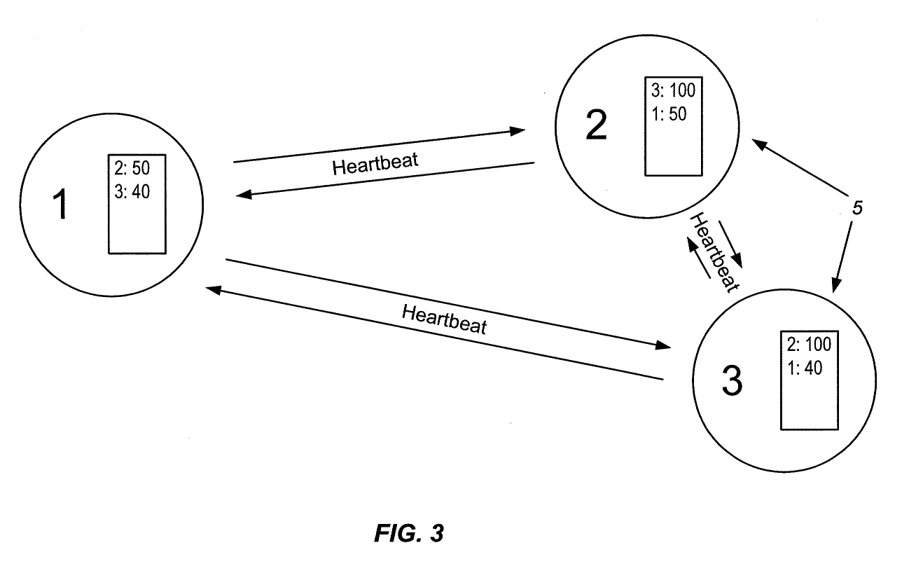

FIG. 3 shows how heartbeat transmissions are sent between peers and how the trust levels (arbitrary values) reflect the distance between peers. Note that node 1 has a trust level of 50 with regard to node 2 and a trust level of 40 with regard to node 3. Note that node 2 has a trust level of 50 with respect to node 1 and a trust level of 100 with respect to node 3. Finally, note that node 3 has a trust level of 100 with regard to node 2, and a trust level of 40 with respect to node 1.

The preceding has been a description of a preferred embodiment of our invention. It will be appreciated that various modifications and embellishments may be made to the respective components and network operations without departing from the spirit of the invention. For example, while the invention has been described in conjunction with a radio signal-based network operating in conjunction with IEEE 802.15.4, it will be appreciated that other network protocol technology may be employed in place of this. Furthermore, if desired, an optical network may be employed in place of the radio network described. In such an implementation the network nodes will each have photo sensors and light emitting devices such as LEDs. The scope of the invention is defined by the appended claims.

What is claimed is:

1. In a trust based network having a plurality of nodes, each node having a node device, a node device comprising:
a processor;
a memory coupled to the processor;
a transceiver coupled to the processor, the transceiver capable of transmitting signals to a second node device in the network and receiving signals from the second node device in the network; and
wherein the node device determines proximity of the second node device in the network and establishes a trust level for such second node device, the trust level for the second node device being based at least on proximity of the second node device to the node device.

2. A node device as in claim 1 wherein the trust level controls flow of information from the node device to the second node device.

3. A node device as in claim 2 wherein the proximity of the second node is determined by strength of a heartbeat signal transmitted by the second node.

4. A node device as in claim 3 wherein the heartbeat signal transmitted by the second node comprises a identification signal identifying the second node device.

5. A node device as in claim 4 wherein the second node device includes a processor;
a memory coupled to the processor; a transceiver coupled to the processor, the transceiver capable of transmitting signals to other node devices in the network and receiving signals from the other node devices in the network; and the heartbeat signal transmitted by the second node further comprises a class membership identifying an application being executed by the second node.

6. A node device as in claim 5 wherein the node device also executes an application, and the trust level for the second node device is increased if the node device and the second node device are executing the same application.

7. A node device as in claim 1 wherein the trust level for the second node device is also based upon an amount of time elapsing since the heartbeat signal was last previously received from the second node device.

8. A node device as in claim 1 wherein the trust level is at least partially based upon a previous trust level for the second node device.

9. A node devise as in claim 1 further comprising a sensor coupled to the node device for sensing an external condition at the node device.

10. A node device as in claim 1 further comprising a peripheral device coupled to the node device for emitting light or sound.

11. A node device as in claim 1 wherein the trust level is determined by:
$${T}_{n + 1} = min \{ 100 \vert {T}_{n} \times D + \frac{S \times C}{min \{ 10 \vert P \}} \}$$
where:
Tₙ₊₁ is a new trust level;
Tₐ is a previous trust level limited to 100.
S is the signal strength of a last received heartbeat;
P is an active peer count, determined by counting peers where the last received heartbeat is less than 60 seconds old;
C is a commonality factor which is related to whether the node device and the second node device execute a common application; and
D is a decay factor which begins at
$$\frac{999}{1000} ,$$
and reduces by 0.1% every 10 seconds.

12. A node device as in claim 1 wherein the transceiver operates in compliance with IEEE 802.15.4.

13. A method of providing a trust based network of node devices, each capable of emitting and receiving electromagnetic wave signal comprising:
causing each node device to emit a heartbeat signal identifying that device;
at a first node device receiving the heartbeat signal emitted by a second node device;
at the first node device performing a calculation of a trust level based at least on strength of the heartbeat signal received from the second node device; and
at the first node device controlling transmission of information from the second node device to the first node device based at least in part on the trust level calculated.

14. A method as in claim 13 wherein the trust level is further based on a class membership identifying an application being executed by the second node.

15. A method as in claim 14 wherein the trust level is further based upon an amount of time elapsing since the heartbeat signal was last previously received from the second node device.

16. A method as in claim 13 wherein the trust level is at least partially based upon a previous trust level for the first node device.

17. A method as in claim 13 wherein the first node device emits light or sound in response to receiving a signal from the second node device.

18. A method as in claim 13 wherein the trust level is determined by:
$${T}_{n + 1} = min \{ 100 \vert {T}_{n} \times D + \frac{S \times C}{min \{ 10 \vert P \}} \}$$
where:
ₙ₊₁ is a new trust level;
Tₙ is a previous trust level limited to 100.
S is the signal strength of a last received heartbeat;
P is an active peer count, determined by counting peers where the last received heartbeat is less than 60 seconds old;
C is a commonality factor which is related to whether the node device and the second node device execute a common application; and
D is a decay factor which begins at
$$\frac{999}{1000} ,$$
and reduces by 0.1% every 10 seconds.
